(19) United States
(12) Patent Application Publication
(10) Pub. No.: US 2022/0395855 A1
(43) Pub. Date: Dec. 15, 2022

(54) CAULKING SYSTEM AND CAULKING ACCESSORY

(71) Applicant: Patrick J. Dugas, Winter Haven, FL (US)

(72) Inventor: Patrick J. Dugas, Winter Haven, FL (US)

(21) Appl. No.: 17/891,085

(22) Filed: Aug. 18, 2022

Related U.S. Application Data
(60) Provisional application No. 63/331,229, filed on Apr. 14, 2022.

(51) Int. Cl. B05C 17/005; B05C 17/01

(52) U.S. Cl. CPC B05C 17/00576; B05C 17/0133

(57) ABSTRACT

Caulking systems and caulking system accessories are described herein.

### RELATED APPLICATIONS

This application claims the benefit of U.S. Provisional No. 63/331,229, entitled “Caulking System and Caulking Accessory”, filed on Apr. 14, 2022, which is incorporated herein by reference in its entirety.

### FIELD

Some implementations relate generally to caulking, and, more particularly, to manually operated caulk guns and caulk tubes.

### BACKGROUND

Conventional manual caulk systems (e.g., FIGS. 1 and 2) may include a caulk gun 102 having a plunger rod 104 and a gun plunger 106. The plunger rod 104 is advanced by squeezing a trigger handle 108 causing the gun plunger 106 to press against a caulk plunger 112 within a tube of caulk 110. The caulk plunger creates a pressure within the caulk tube 110 and causes caulk to exit the caulk tube 110 via a nozzle (as shown by the arrows).

As shown in FIG. 2, when the pressure on the trigger handle 108 is released and the plunger rod 104 and gun plunger 106 are withdrawn from the caulk tube 110, the caulk plunger 112 remains in the same position and continues to exert pressure within the caulk in the caulk tube 110 causing caulk to flow for a time period after the pressure from the gun plunger 106 is removed.

Embodiments were conceived in light of the above mentioned problems and limitations, among other things.

### SUMMARY

Some implementations can include a caulking accessory system comprising a caulk gun plunger member configured to attach to a caulk gun plunger, the caulk gun plunger member having at least one protrusion. The accessory system can also include a caulk tube plunger member configured to attach to a caulk tube plunger, caulk tube plunger member having at least one receptacle corresponding to the at least one protrusion of the caulk gun plunger member, the receptacle configured to releasably receive the protrusion when the caulk gun plunger member is in a first orientation relative to the caulk tube plunger member and to engage and retrain the protrusion when the caulk gun plunger member is in a second orientation relative to the caulk tube plunger member.

Some implementations can include a caulking system having a caulk gun having a caulk gun plunger member having at least one protrusion. The system can also include a caulk tube having a caulk tube plunger having at least one receptacle corresponding to the at least one protrusion of the caulk gun plunger, the receptacle configured to releasably receive the protrusion when the caulk gun plunger is in a first orientation relative to the caulk tube plunger and to engage and retrain the protrusion when the caulk gun plunger is in a second orientation relative to the caulk tube plunger.

### BRIEF DESCRIPTION OF THE DRAWINGS

FIG. 1 shows a diagram of a conventional manual caulking system.

FIG. 2 shows a diagram of a conventional manual caulking system.

FIGS. 3-6 show an example of a manual caulk system having a gun plunger/caulk tube plunger engagement system according to some implementations.

FIGS. 7A-7B and 8A-8B show diagrams of an example gun plunger/caulk tube plunger engagement system according to some implementations.

FIG. 9 shows a manual caulking system having an integrated gun plunger/caulk tube plunger engagement system according to some implementations.

FIGS. 10A and 10B are diagrams of an example gun plunger/caulk tube plunger engagement system according to some implementations.

FIG. 11 is a diagram of an example gun plunger/caulk tube plunger engagement system according to some implementations.

FIG. 12 is a diagram of an example caulk gun with an example plunger/tube engagement system in accordance with some implementations.

FIG. 13 is a diagram showing detail of an example plunger end and caulk tube engagement feature prior to engagement in accordance with some implementations.

FIG. 14 is a diagram showing detail of an example plunger end and caulk tube engagement feature after engagement in accordance with some implementations.

FIG. 15 is a cross-sectional diagram showing detail of an example plunger end and caulk tube engagement feature prior to engagement in accordance with some implementations.

FIG. 16 is a cross-sectional diagram showing detail of an example plunger end and caulk tube engagement feature after engagement in accordance with some implementations.

FIG. 17 is a diagram of an example caulk gun with an example plunger/tube engagement system in accordance with some implementations.

FIG. 18 is a diagram of an example caulk gun with an example plunger/tube engagement system in accordance with some implementations.

FIG. 19 is a diagram of an example caulk gun with an example plunger/tube engagement system in accordance with some implementations.

FIG. 20 is a diagram of an example caulk gun with an example plunger/tube engagement system in accordance with some implementations.

FIG. 21 is a diagram of an example caulk gun plunger/tube engagement system in accordance with some implementations.

FIG. 22 is a diagram of an example caulk gun plunger/tube engagement system in accordance with some implementations.

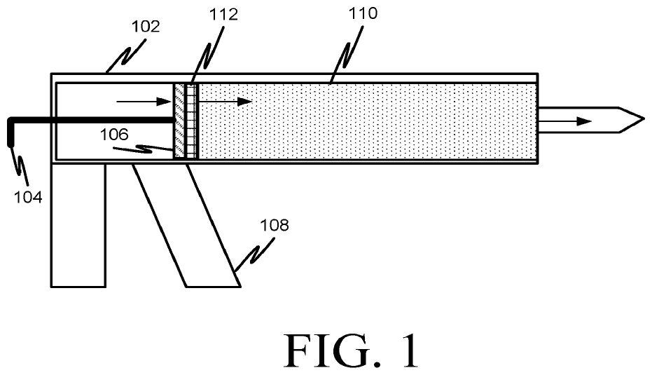

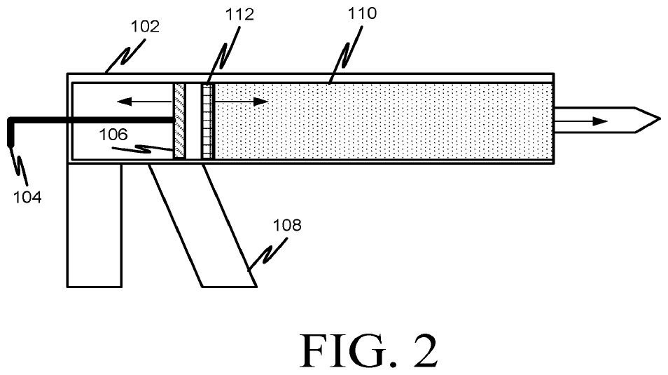

### DETAILED DESCRIPTION

In general, some implementations can include a mechanism to temporarily connect a caulk gun plunger of a caulk gun to a caulk tube plunger, wherein the mechanism permits force to be applied in a first direction along an axis of the caulk gun plunger and in a second direction along the same axis, where the second direction is opposite the first direction.

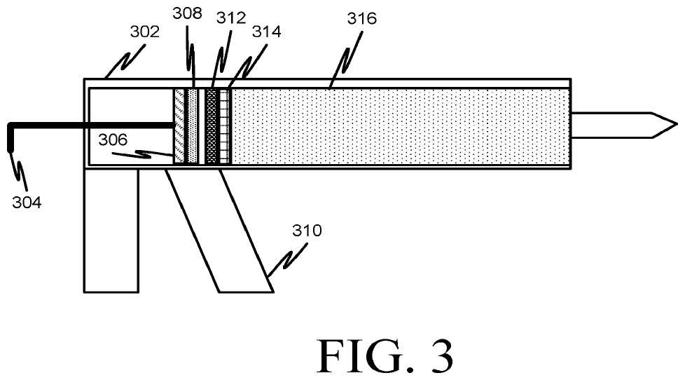

FIG. 3 shows an example caulking accessory system (e.g., engagement system) in place on a conventional caulking system. The conventional caulk gun includes a gun 302, a plunger rod 304, a gun plunger 306 and a gun trigger handle 310. The system also includes a caulk tube 316 having a caulk tube plunger 314.

The accessory system may be added to the conventional caulking system by installing a caulk gun plunger member 308 on the caulk gun plunger 306 and a caulk tube plunger member 312 on the caulk tube plunger 314. The accessory system members may be formed from plastic, metal or other suitable material. The caulk gun plunger member 308 and the caulk tube plunger member 312 may include an adhesive material (not shown) on the side placed against the caulk gun plunger 306 and caulk tube plunger 314, respectively. An accessory system may be provided in a set including one caulk gun plunger member 308 and a plurality of caulk tube plunger members 312.

In a first step to engage the caulk gun plunger member 308 with the caulk tube plunger member 312, the caulk tube plunger 306 is advanced toward the caulk tube plunger 314. When the caulk tube plunger member is in a first position (e.g., with protrusions of the caulk gun plunger member substantially aligned with receptacles of the caulk tube plunger member) protrusions extending from the caulk gun plunger member 308 are received by corresponding receptacles on the caulk tube plunger member 312. Next, the caulk tube plunger member 308 is rotated to a second position by rotating the caulk tube plunger rod 304. The rotation can be, for example, a ninety degree rotation or other suitable rotation amount. When the caulk gun plunger member is rotated to the second position, the protrusions are engaged and retained by the receptacles on the caulk tube plunger member 312 causing the caulk gun plunger member to be releasably coupled to the caulk tube plunger member.

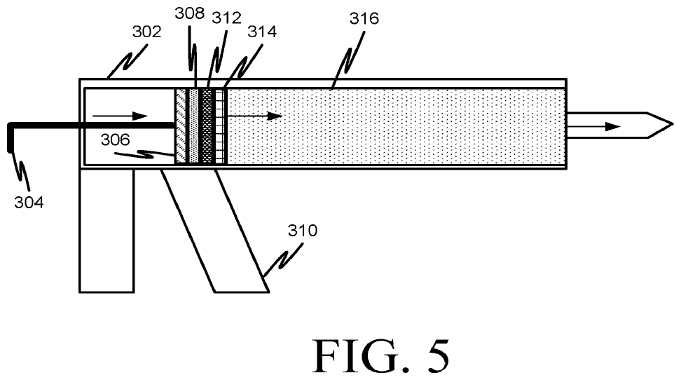

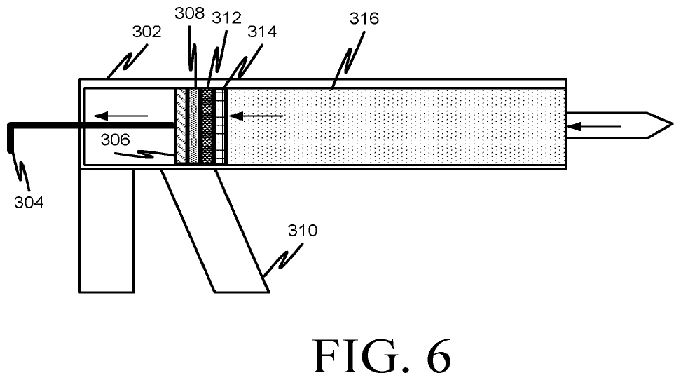

FIG. 5 shows the caulk gun plunger 306 being advanced and causing the caulk gun plunger to press against the caulk tube plunger 314 via the engagement system (308/312). When the user wishes to stop the flow of caulk by withdrawing the caulk gun plunger 306, the engagement system (308/312) causes the caulk tube plunger 314 to withdraw as well due to the connection between the caulk gun plunger member 308 and the caulk tube plunger member 312 (as shown by the arrows in FIG. 6). Thus, little or no caulk will continue to flow when the caulk gun plunger 306 is withdrawn due to the reversal of pressure within the caulk tube 316.

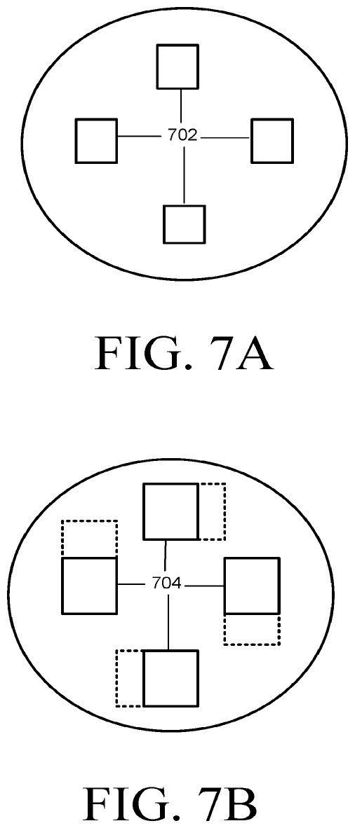

FIGS. 7A and 7B show example front views of a caulk gun plunger member 308 and a caulk tube plunger member 312, respectively. FIG. 7A shows protrusions 702. FIG. 7B shows receptacles 704.

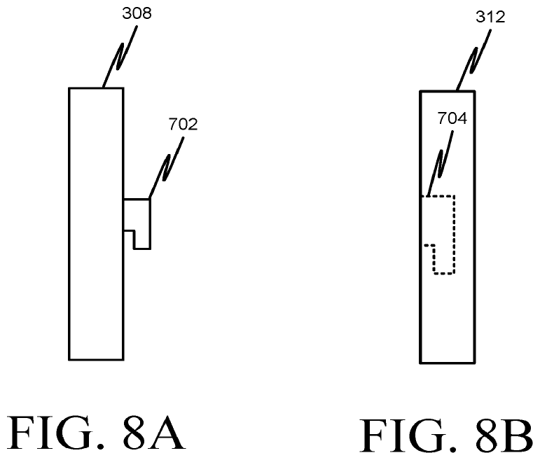

FIGS. 8A and 8B show example front views of a caulk gun plunger member 308 and a caulk tube plunger member 312, respectively. FIG. 8A shows protrusions 702. FIG. 8B shows receptacles 704.

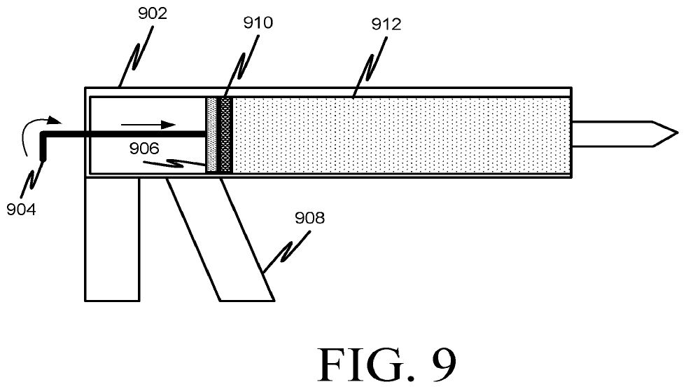

FIG. 9 shows an implementation in which the caulk gun 902 includes a caulk gun plunger rod 304 and a caulk gun plunger 306 configured in a manner similar to the caulk gun plunger member 308 described above (with the exception that an adhesive may not be necessary as the caulk gun plunger 906 may be attached in another manner to the caulk gun plunger rod 904). Also, caulk tubes (e.g., 912) may be manufactured to include a caulk tube plunger 910 that is configured similar to the caulk tube plunger member 312 described above.

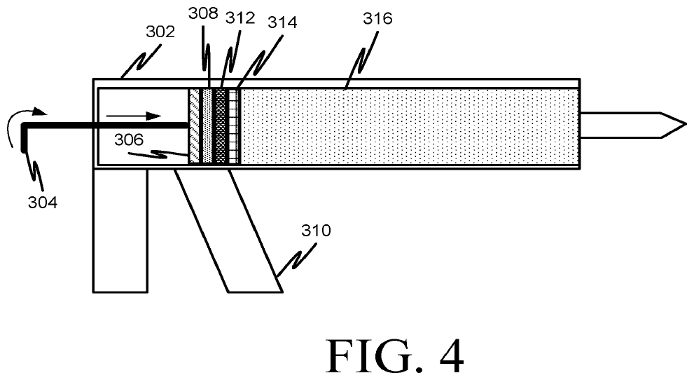

The operation of the system shown in FIG. 9 would be similar to the operation of the system described above in connection with FIGS. 3-6.

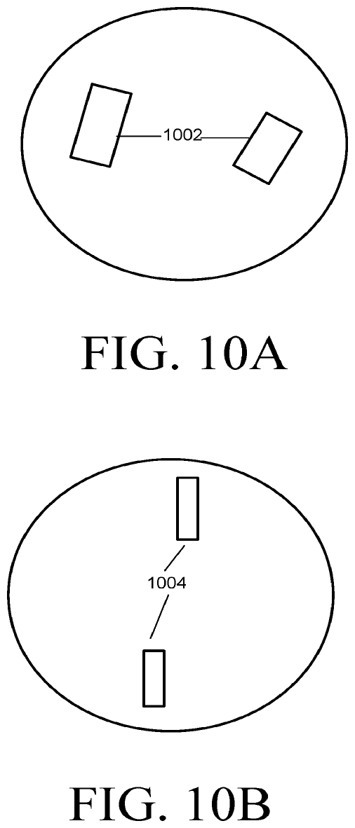

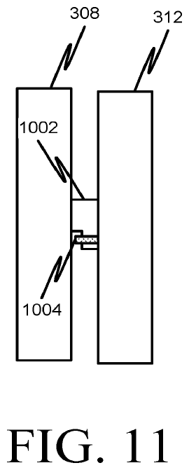

FIGS. 10A and 10B show an example implementation of the system in which the receptacle(s) 1004 are raised from the surface of the caulk tube plunger member. As shown in FIG. 11, the protrusions 1002 are engaged and retained by receptacles 1004 which extend from the surface of the caulk tube plunger. The caulk tube plunger implementations shown in FIGS. 10A, 10B, and 11 may be especially suited to being stamped from metal in order to form the raised receptacles.

In the example implementations mentioned above, the caulk gun plunger 906 or caulk tube plunger member 308 may have protrusions formed in such a manner as to be usable with a convention tube of caulk (e.g., the protrusions may be spaced in such a way and be strong enough to push the plunger of a conventional tube of caulk without the protrusions engaging corresponding receptacles).

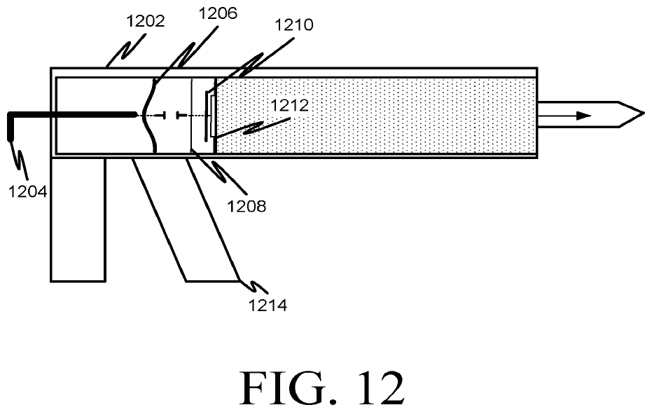

FIG. 12 is a diagram of an example caulk gun with an example plunger/tube engagement system in accordance with some implementations. In particular, FIG. 12 shows an example caulk gun 1202 having a caulk gun plunger rod 1204, a caulk gun plunger 1206, an optional paper guide 1208, a caulk tube tab 1210, a caulk tube plunger 1212, and a gun trigger handle 1214.

The engagement system includes the caulk gun plunger 1206 and the caulk tube tab 1210, which can be manufactured as part of the caulk gun and caulk tube or can be supplied as an accessory to a standard caulk gun and standard caulk tube.

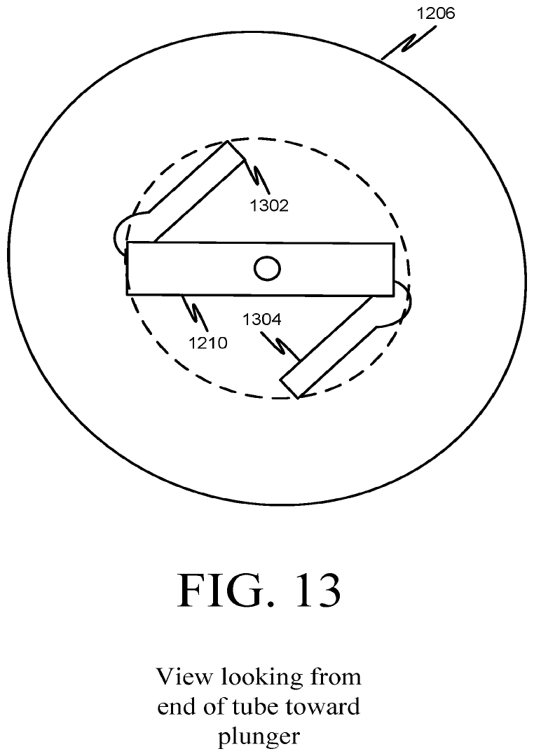

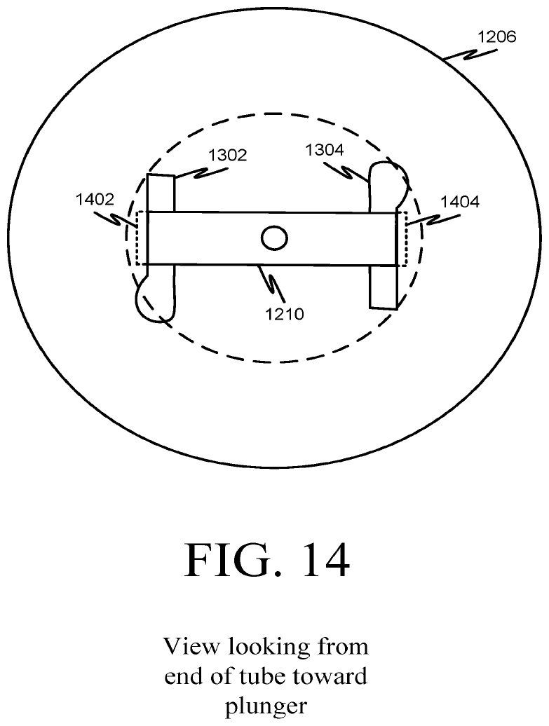

The accessory system may be added to the conventional caulking system by installing the caulk gun plunger 1206 on the caulk gun plunger rod 1204 (e.g., via a screw) and a caulk tube tab 1210 on the caulk tube plunger 1212. The accessory system members may be formed from plastic, metal or other suitable material. The caulk gun plunger 1206 includes one or more slots (shown in FIGS. 13 and 14) that cooperate with the caulk tube tab 1210 to engage the caulk gun plunger 1206 and the caulk tube tab 1210, which is attached to the caulk tube plunger 1212 (e.g., via a screw, molded into the caulk tube plunger, attached via adhesive, or the like). An accessory system may be provided in a set including one caulk gun plunger 1206 and a plurality of caulk tube tabs 1210.

In a first step to engage the caulk gun plunger 1206 with the caulk tube tab 1210, the caulk gun plunger 1206 is advanced toward the caulk tube tab 1210 (e.g., via the caulk gun plunger rod 1204 and the caulk gun trigger 1214). When the caulk gun plunger 1206 is in a first position (e.g., with protrusions of the caulk tube tab 1210 substantially aligned with receptacles or slots (e.g., 1302 or 1304 in FIG. 13) of the caulk gun plunger 1206 and protrusions extending from the caulk tube tab 1210 are received by corresponding receptacles or slots on the caulk gun plunger 1206. This first position is shown in FIG. 13.

Next, the caulk tube plunger member 308 is rotated to a second position (shown in FIG. 14) by rotating the caulk gun plunger 1206 (or caulk tube, if the caulk gun plunger doesn't rotate). The rotation can be, for example, a ninety-degree rotation or other suitable rotation amount. When the caulk gun plunger 1206 is rotated to the second position, the receptacles or slots of the caulk gun plunger 1206 engage and retain protrusions (see, 1402 and 1404 in FIG. 14) on the caulk tube tab 1210, which is attached to the caulk tube plunger 1212 causing the caulk gun plunger 1206 to be releasably coupled to the caulk tube plunger 1212.

In the example implementations mentioned above, the caulk gun plunger 1206 or caulk tube tab 1210 may be formed in such a manner as to be usable with a conventional tube of caulk and/or conventional caulk gun (e.g., the protrusions of the caulk tube tab 1210 may be spaced in such a way and be strong enough to push the plunger of a conventional tube of caulk and the caulk gun plunger 1206 may be configured to replace a conventional caulk gun plunger).

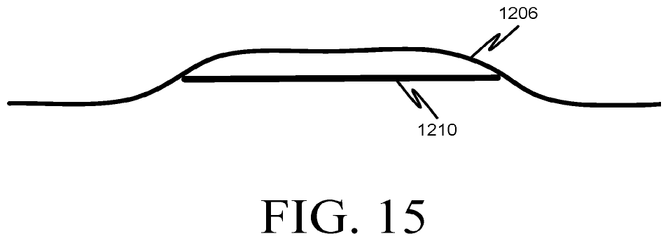

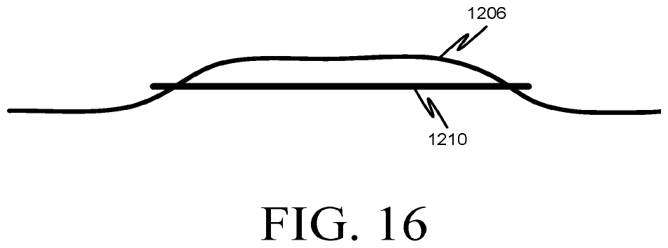

FIG. 15 is a cross-sectional diagram showing detail of an example caulk gun plunger 1206 and caulk tube tab 1210 feature prior to engagement in accordance with some implementations. FIG. 16 is a cross-sectional diagram showing detail of an example caulk gun plunger 1206 and caulk tube tab 1210 after engagement in accordance with some implementations.

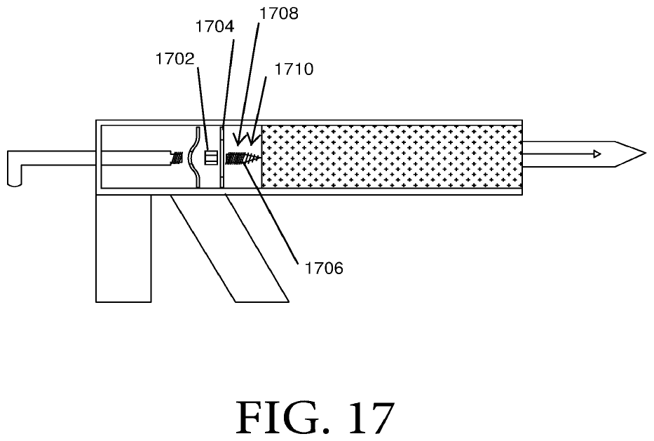

FIG. 17 is a diagram of an example caulk gun with an example plunger/tube engagement system in accordance with some implementations. In particular, FIG. 17 shows a plunger/tube engagement system including a coupling nut 1702, an optional spacer 1704, and a hanger bolt 1706 having a machine thread section 1708 and a self-tapping wood screw section 1710.

In operation, one end of the coupling nut 1702 can be threaded onto the threaded end of the plunger rod and the hanger bolt 1706 can be threaded into the other end of the coupling nut 1702. Then, the plunger rod or the caulk tube can be rotated to cause the self-tapping wood screw section 1710 of the hanger bolt 1706 to tap into the plunger of the caulk tube so as to releasably couple the caulk tube plunger and the caulk gun plunger rod to permit the plunger rod to retract and cause the caulk tub plunger to retract to stop a flow of caulk as discussed above. The optional spacer 1704 can include a plastic (or other material) spacer with an adhesive on one side to attached the space to the caulk gun plunger to extend the caulk gun plunger so that it can press the caulk tube plunger without the coupling nut contacting the caulk tube plunger.

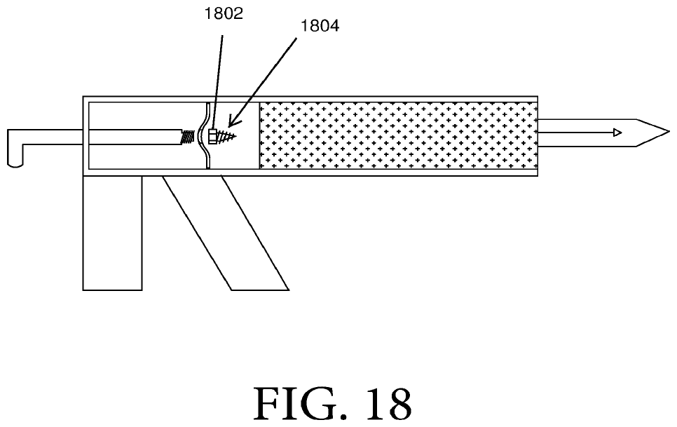

FIG. 18 is a diagram of an example caulk gun with an example plunger/tube engagement system in accordance with some implementations. In particular, FIG. 18 shows a nut 1802 to attach the caulk gun plunger to the plunger rod, where the nut includes a self-tapping screw 1804 to permit the plunger rod or the caulk tube to be rotated to cause the self-tapping screw section 1804 to tap into the plunger of the caulk tube so as to releasably couple the caulk tube plunger and the caulk gun plunger rod to permit the plunger rod to retract and cause the caulk tub plunger to retract to stop a flow of caulk as discussed above.

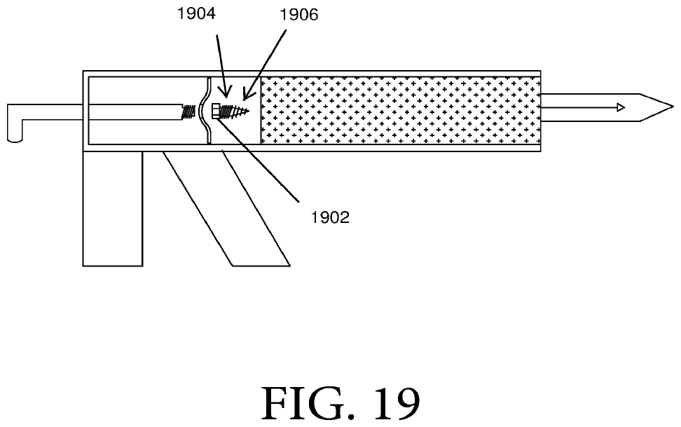

FIG. 19 is a diagram of an example caulk gun with an example plunger/tube engagement system in accordance with some implementations. The example implementation in FIG. 19 is similar to that shown in FIG. 18 with the exception that FIG. 19 shows a nut 1902 having a self-tapping wood screw section 1906 with a section 1904 of finer threads (e.g., machine bolt type threads) between the nut 1902 and the self-tapping wood screw section 1906.

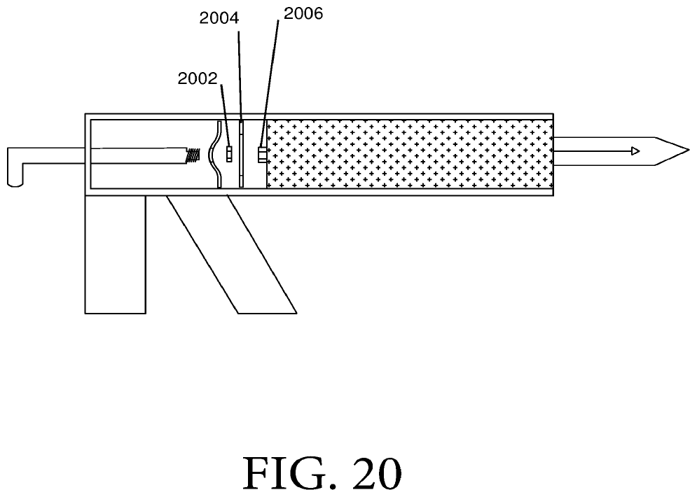

FIG. 20 is a diagram of an example caulk gun with an example plunger/tube engagement system in accordance with some implementations. In particular, FIG. 20 shows a nut 2002 to attach the caulk gun plunger to the plunger rod. The nut 2002 may be thinner than typical caulk gun plunger nuts and may be open on both sides to permit the nut to be threaded onto the caulk gun plunger rod along with the caulk gun plunger and still permit some threaded portion of the caulk gun plunger rod to extend beyond the nut 2002. The extended portion of the caulk gun rod threads are configured to engage a molded in place nut 2006 on the caulk tube plunger.

The plunger rod or the caulk tube can be rotated to cause the exposed threads of the caulk gun plunger rod releasably engage the molded in place nut 2006 of the caulk tube plunger so as to releasably couple the caulk tube plunger and the caulk gun plunger rod to permit the plunger rod to retract and cause the caulk tub plunger to retract to stop a flow of caulk as discussed above. An optional spacer 2004 (similar to 1704) can be used to space the caulk gun plunger from the caulk tube plunger as needed.

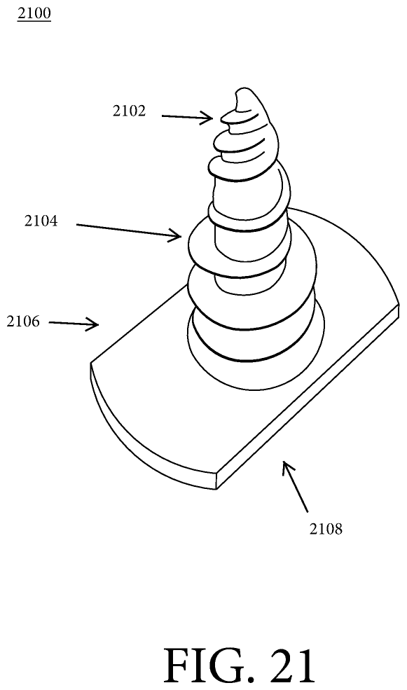

FIG. 21 shows a diagram of an example plunger/tube engagement system 2100 in accordance with some implementations. The plunger/tube engagement system 2100 is configured to be an OEM part for a caulk gun or a retrofit part for a conventional caulk gun. The plunger/tube engagement system 2100 includes a first threaded portion 2102 that is constructed to pierce a caulk tube plunger and auger into the caulk tube. The plunger/tube engagement system 2100 also includes a second threaded section 2104 that augers into a hole in the caulk tube plunger made by the first threaded portion 2102 and causes the plunger/tube engagement system 2100 to couple to the caulk tube plunger. The plunger/tube engagement system 2100 also includes a caulk gun plunger section 2106 configured to press the caulk tube plunger when the caulk gun trigger is pulled. The caulk gun plunger section 2106 includes flat portions 2108 that permit the plunger/tube engagement system 2100 to be engaged by a tool tighten the plunger/tube engagement system 2100 onto the threaded end of a caulk gun plunger rod. The internal threaded portion of the plunger/tube engagement system 2100 that threads onto the threaded end of the caulk gun plunger rod is not shown in FIG. 21.

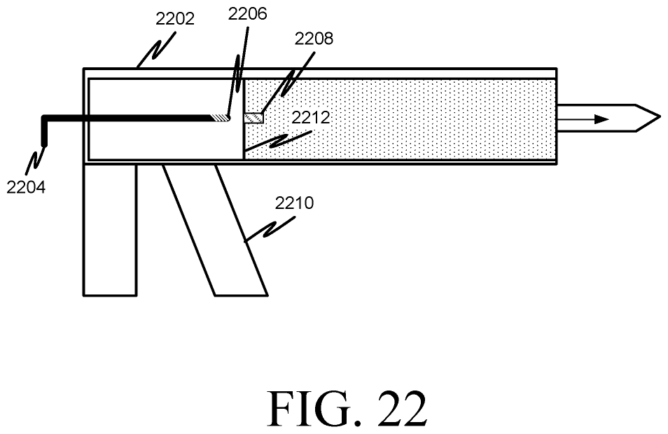

FIG. 22 is a diagram of an example caulk gun with an example plunger/tube engagement system in accordance with some implementations. In particular, FIG. 22 shows an example caulk gun 2202 having a caulk gun plunger rod 2204, a threaded caulk gun plunger rod end 2206, an internally threaded caulk tube aperture 2208, a gun trigger handle 2210, and a caulk tube plunger 2212.

In operation, the caulk gun plunger rod end 2206 can be threaded into the internally threaded caulk tube aperture 2208 to secure the caulk gun plunger rod 2204 to the caulk tube plunger 2212 so that when the gun trigger handle is pulled, the plunger rod 2204 applied pressure against the caulk tube plunger and forces caulk to be expelled. When the caulking process is complete, the user can pull back on the plunger rod and the caulk tube plunger will also move back because of the connection between the caulk gun plunger do treaded end 2206 and the internally threaded caulk tube aperture 2208.

While some implementations have been described in terms of a general embodiment with several specific modifications, it is recognized that persons skilled in this art will readily perceive many other modifications and variations of the embodiments described above. Applicant intends to embrace any and all such modifications, variations and embodiments.

What is claimed is:

1. A caulking system comprising:
a caulk gun having a caulk gun plunger rod with a threaded end; and
a caulk tube having a caulk tube plunger with an internally threaded aperture that is configured to be engaged by the caulk gun plunger rod threaded end.

2. A caulking apparatus comprising:
a mechanism to temporarily connect a caulk gun plunger of a caulk gun to a caulk tube plunger, wherein the mechanism permits force to be applied in a first direction along an axis of the caulk gun plunger and in a second direction along the same axis, where the second direction is opposite the first direction.
